(19) United States
(12) Patent Application Publication
(10) Pub. No.: US 2026/0022256 A1
(43) Pub. Date: Jan. 22, 2026

(54) ANTI-FOG, ANTI-REFLECTIVE COATINGS PRODUCED BY AEROSOL IMPACT-DRIVEN ASSEMBLY

(71) Applicant: Swift Coat, Inc., Phoenix, AZ (US)

(72) Inventors: Peter Alexander Firth, Tempe, AZ (US); Zachary Holman, Phoenix, AZ (US)

(21) Appl. No.: 19/275,548

(22) Filed: Jul. 21, 2025

Related U.S. Application Data
(60) Provisional application No. 63/673,758, filed on Jul. 21, 2024.

(51) Int. Cl. C09D 5/16; C08J 7/06; C09D 1/00; C09D 5/00; C09D 5/33

(52) U.S. Cl. CPC C09D 5/1618; C08J 7/06; C09D 1/00; C09D 5/002; C09D 5/004; C08J 2369/00

(57) ABSTRACT

A coated substrate includes a substrate, an anti-fog layer, and a bonding layer between the substrate and the anti-fog layer. The anti-fog layer includes SiO₂, and the bonding layer is an optically transparent inorganic material. Fabricating the coated substrate includes disposing the bonding layer on the substrate and optionally disposing one or more optical layers on the bonding layer to yield an intermediate coated substrate, and disposing the anti-fog layer on the intermediate coated substrate to yield the coated substrate.

### CROSS-REFERENCE TO RELATED APPLICATION

This application claims the benefit of U.S. Patent Application No. 63/673,758 filed on Jul. 21, 2024, which is incorporated by reference herein in its entirety.

### TECHNICAL FIELD

This invention relates to multilayer coatings, including anti-fog coatings and anti-fog, anti-reflective coatings, produced by aerosol impact-driven assembly and methods of fabricating the coatings.

### BACKGROUND

Fogging occurs when water present in humid air condenses onto a substrate with a temperature at or below the dew point. Droplets on the surface with diameters comparable to or larger than the wavelengths of visible light scatter incident light diffusely, resulting in a hazy image transmitted through or reflected from the substrate. Depending on the application, the consequences of this condensation-induced haze range from annoying, like a fogged bathroom mirror after a hot shower, to dangerous, like fogged eyewear obscuring vision.

### SUMMARY

This disclosure describes multilayer coatings, including anti-fog (AF) coatings and anti-fog, anti-reflective (AFAR) coatings produced by aerosol impact-driven assembly and methods of fabricating the coatings.

Although the disclosed inventive concepts include those defined in the attached claims, it should be understood that the inventive concepts can also be defined in accordance with the following embodiments.

Embodiment 1 is a coated substrate comprising:
a substrate;
an anti-fog layer; and
a bonding layer between the substrate and the anti-fog layer,
wherein the anti-fog layer comprises SiO₂, and the bonding layer is an optically transparent inorganic material.

As used herein, “substrate” generally refers to the substrate in the absence of the claimed layer(s).

Embodiment 2 is the coated substrate of embodiment 1, wherein the anti-fog layer consists of SiO₂.

Embodiment 3 is the coated substrate of embodiment 1 or 2, wherein the bonding

layer comprises a metal oxide.

Embodiment 4 is the coated substrate of embodiment 3, wherein the bonding layer comprises TiO₂.

Embodiment 5 is the coated substrate of embodiment 4, wherein the bonding layer consists of TiO₂.

Embodiment 6 is the coated substrate of any one of embodiments 1-5, wherein a thickness of the bonding layer is in a range of about 5 nm to about 25 nm.

Embodiment 7 is the coated substrate of embodiment 6, wherein a thickness of the bonding layer is in a range of about 6 nm to about 12 nm.

Embodiment 8 is the coated substrate of any one of embodiments 1-7, wherein a refractive index of the bonding layer is in a range of about 1.8 to about 2.2.

Embodiment 9 is the coated substrate of embodiment 8, wherein a refractive index of the bonding layer is in a range of about 1.9 to about 2.1.

Embodiment 10 is the coated substrate of any one of embodiments 1-9, wherein a thickness of the anti-fog layer is in a range of about 50 nm to about 1000 nm.

Embodiment 11 is the coated substrate of embodiment 10, wherein a thickness of the anti-fog layer is in a range of about 75 nm to about 200 nm.

Embodiment 12 is the coated substrate of any one of embodiments 1-11, wherein a refractive index of the anti-fog layer is in a range of about 1.20 to about 1.45.

Embodiment 13 is the coated substrate of embodiment 12, wherein a refractive index of the anti-fog layer is in a range of about 1.25 to about 1.40.

Embodiment 14 is the coated substrate of any one of embodiments 1-13, wherein a surface roughness of the anti-fog layer is in a range of about 25 nm to about 150 nm.

Embodiment 15 is the coated substrate of embodiment 14, wherein a surface roughness of the anti-fog layer is in a range of about 30 nm to about 80 nm.

Embodiment 16 is the coated substrate of any one of embodiments 1-15, wherein the anti-fog layer comprises particles having a dimension in a range between about 5 nm and about 300 nm.

Embodiment 17 is the coated substrate of any one of embodiments 1-16, wherein the substrate is optically transparent.

Embodiment 18 is the coated substrate of embodiment 17, wherein the substrate comprises a polymer.

Embodiment 19 is the coated substrate of embodiment 18, wherein the substrate comprises polycarbonate.

Embodiment 20 is the coated substrate of any one of embodiments 1-19, wherein the coated substrate has a water contact angle of <10 degrees.

Embodiment 21 is the coated substrate of embodiment 20, wherein the coated substrate has a water contact angle of <10 degrees after 250 abrasion cycles on a Taber linear abraser with cheese cloth soaked in deionized water and a pressure of 3 lb/in².

Embodiment 22 is the coated substrate of embodiment 20, wherein the coated substrate has a water contact angle of <10 degrees after 24 hours of soaking in deionized water, deionized water with detergent, isopropanol, or window cleaner.

Embodiment 23 is the coated substrate of any one of embodiments 1-22, wherein the coated substrate has a color difference of transmitted light of ΔE_{transmitted}<2 relative to the substrate.

Embodiment 24 is the coated substrate of any one of embodiments 1-23, wherein the coated substrate has a change in color difference of reflected light of ΔE_{reflected}<0.2 after 250 abrasion cycles on the Taber linear abraser with damp cheese cloth and a pressure of 3 lb/in².

Embodiment 25 is the coated substrate of any one of embodiments 1-24, wherein the coated substrate has a change in color difference of reflected light of ΔE_{reflected}<0.4 after 24 hours of soaking in deionized water, deionized water with detergent, isopropanol, or window cleaner.

Embodiment 26 is the coated substrate of any one of embodiments 1-25, wherein the coated substrate has an average reflectance of >3% lower than the substrate.

Embodiment 27 is the coated substrate of any one of embodiments 1-26, wherein the coated substrate has a change in average reflectance of <0.2% after 250 abrasion cycles on the Taber linear abraser with damp cheese cloth and a pressure of 3 lb/in².

Embodiment 28 is the coated substrate of any one of embodiments 1-27, wherein the coated substrate has a change in average reflectance of <0.3% after 24 hours of soaking in deionized water, deionized water with detergent, isopropanol, or window cleaner.

Embodiment 29 is the coated substrate of any one of embodiments 1-28, further comprising further comprising a first optical layer and a second optical layer, wherein the first optical layer is between the bonding layer and the anti-fog layer, and the second optical layer is between the first optical layer and the anti-fog layer.

Embodiment 30 is the coated substrate of embodiment 29, wherein the anti-fog layer and the first optical layer are composed of the same material.

Embodiment 31 is the coated substrate of embodiment 30, wherein the anti-fog layer and the first optical layer have the same thickness ±10%.

Embodiment 32 is the coated substrate of embodiment 29, wherein the bonding layer and the second optical layer are composed of the same material.

Embodiment 33 is the coated substrate of embodiment 32, wherein the bonding layer and the second optical layer have the same thickness ±10%.

Embodiment 34 is the coated substrate of any one of embodiments 1-33, wherein the coated substrate has a spectral shape difference of reflected light of STD<1.5 relative to the substrate.

Embodiment 35 is the coated substrate of any one of embodiments 1-34, further comprising one or more optical layers between the bonding layer and the anti-fog layer.

Embodiment 36 is a method of fabricating the coated substrate of embodiment 1, the method comprising:
disposing the bonding layer on the substrate and optionally disposing one or more optical layers on the bonding layer to yield an intermediate coated substrate; and
disposing the anti-fog layer on the intermediate coated substrate to yield the coated substrate.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIGS. 1A-1C show schematic cross-sectional views of exemplary coated substrates. FIG. 1A shows a cross-sectional view of an exemplary substrate coated on one side with a two-layer coating. FIG. 1B shows a cross-sectional view of an exemplary substrate coated on two-sides, each with a two-layer coating. FIG. 1C shows a cross-sectional view of an exemplary substrate coated on one side with a three-layer coating. FIG. 1D shows a cross-sectional view of an exemplary substrate coated on one side with a four-layer coating. FIG. 1E shows a cross-sectional view of an exemplary substrate coated on one side with a six-layer coating.

FIG. 2 shows a schematic of an aerosol impact-driven assembly (AIDA) system and the AIDA deposition process.

FIGS. 3A-3F show scanning electron microscope (SEM) cross sections of layers deposited with AIDA. FIGS. 3A-3C show SEM cross sections of SiO₂ layers with varying porosity. FIGS. 3D-3F show SEM cross sections of SiO₂ layers with varying surface roughness with corresponding water contact angle images.

FIGS. 4A and 4B show a comparison of polycarbonate transmittance and reflectance spectra, respectively. FIG. 4A shows transmittance spectra of measured and simulated uncoated polycarbonate. FIG. 4B shows reflectance spectra of measured and simulated uncoated polycarbonate.

FIG. 5 shows a diagram of simulated AIDA anti-fog, anti-reflective (AFAR) coatings on a polycarbonate substrate.

FIG. 6 shows weighted transmittance results of simulated AIDA AFAR coatings on a polycarbonate substrate.

FIGS. 7A and 7B show topography of a low average surface roughness (Rₐ) AFAR coating and a high Rₐ AFAR coating, respectively, collected using atomic force microscopy (AFM).

FIG. 8 shows reflectance spectra of uncoated polycarbonate (upper trace), low Rₐ (intermediate trace, extending from the upper trace to the lower trace), and high Rₐ (lower trace) AFAR coatings.

FIGS. 9A-9C show anti-fog performance of AFAR coatings during an anti-fog performance test (“coffee cup test”) as described herein. FIGS. 9A, 9B, and 9C show the results of uncoated polycarbonate, low Rₐ, and high Rₐ AFAR coated polycarbonate, respectively, during an anti-fog performance test. The inset in each image shows the corresponding water contact angle.

FIGS. 10A-10E show results of mechanical durability tests of high Rₐ AFAR coated polycarbonate. FIG. 10A shows reflectance spectra before and after abrasion testing. FIGS. 10B and 10C show contact angle measurements before and after abrasion testing, respectively. FIGS. 10D and 10E show top-down SEM images of the sample before and after abrasion testing, respectively.

FIGS. 11A-11D show reflectance spectra of uncoated polycarbonate and high Rₐ AFAR coated polycarbonate before (solid) and after (dashed) soaking in a cleaning solution for 24 hours. FIG. 11A shows reflectance spectra after soaking in deionized (DI) water. FIG. 11B shows reflectance spectra after soaking in DI water with detergent. FIG. 11C shows reflectance spectra after soaking in isopropanol. FIG. 11D shows reflectance spectra after soaking in window cleaner. Below each plot are water contact angle images of each sample after completion of the soak tests.

FIG. 12 shows an x-ray photoelectron spectroscopy (XPS) spectrum of the anti-fog layer of a high Rₐ AFAR coating.

FIG. 13 shows a map of weighted reflectance produced from 25 reflectance measurements taken in a 5×5 grid on a 30.5 cm×30.5 cm (12 in×12 in) AFAR coated polycarbonate sample.

FIGS. 14A and 14B show photographs of 30.5 cm×30.5 cm (12 in×12 in) uncoated and AFAR coated polycarbonate samples, respectively, undergoing a scaled-up version of the anti-fog performance test.

FIG. 15 shows reflectance measurements of AFAR coated polycarbonate samples produced on four separate days.

FIG. 16 shows transmittance spectra of uncoated polycarbonate, polycarbonate coated with the high Rₐ AFAR coating on one side, and polycarbonate coated on both sides with a version of the AFAR coating designed to maximize transmittance.

FIGS. 17A and 17B show photographs of a flat polycarbonate substrate with and without an AFAR coating after undergoing a modified version of a coffee cup test, respectively.

FIGS. 18A and 18B show tests of an AFAR coated polycarbonate substrate. FIG. 18A shows an average reflectance spectrum and 95% confidence interval of 13 points measured across the coated sample. FIG. 18B shows a map of weighted reflectance at the 13 points.

FIGS. 19A and 19B show a photograph of an extravehicular mobility unit (xEMU) helmet undergoing a reflectance measurement and reflectance spectra of a helmet's uncoated exterior and AFAR coated interior, respectively.

FIG. 20 shows reflectance spectra of uncoated polycarbonate and polycarbonate coated with an AFAR coating as deposited, after a simulated forming process, and after subsequent abrasion testing.

FIGS. 21A-21C show photographs of AFAR coating deposition onto a curved surface. FIGS. 21A and 21B show photographs of uncoated and AFAR coated plastic cups during a modified anti-fog performance test, respectively. FIG. 21C shows a photograph of uncoated (left) and AFAR coated (right) plastic cups immediately following a modified anti-fog performance test.

In the drawings, AR/AF is used interchangeably with AFAR.

### DETAILED DESCRIPTION

This disclosure describes multilayer coatings, including anti-fog (AF) coatings and anti-fog, anti-reflective (AFAR) coatings produced by aerosol impact-driven assembly (AIDA), and methods of fabricating the coatings. The coatings are formed on substrates. The substrates typically include optically transparent materials including polymer(s), glass, mirrored polymer(s) or glass, or a combination thereof. The substrate can include polycarbonate, polymethyl methacrylate, polyethylene terephthalate, polyethylene, polystyrene, other plastics, glass, tempered glass, aluminum-backed glass, silver-backed glass, or any combination thereof. The substrate may include polycarbonate with no hardcoat (e.g., bare polycarbonate). One example of a suitable substrate is Plaskolite™ TUFFAK® GP.

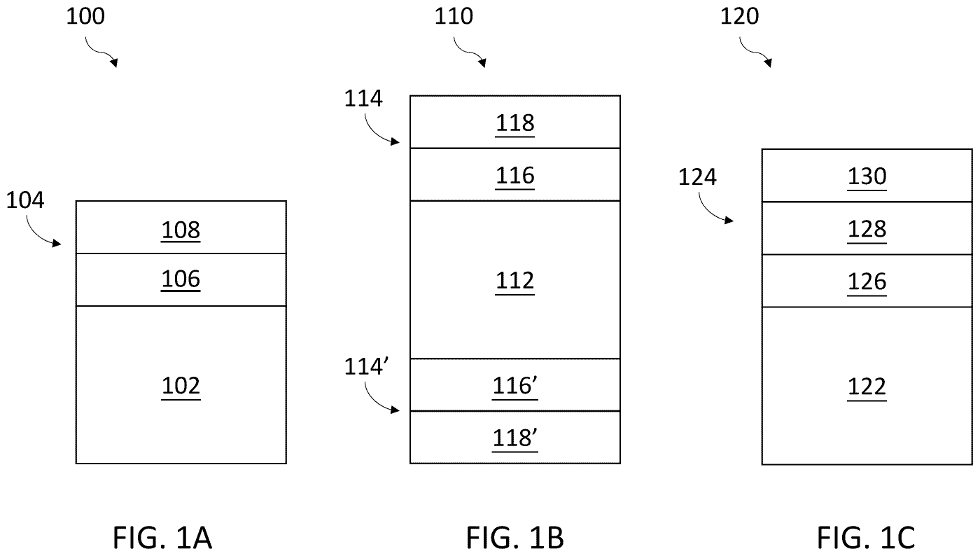

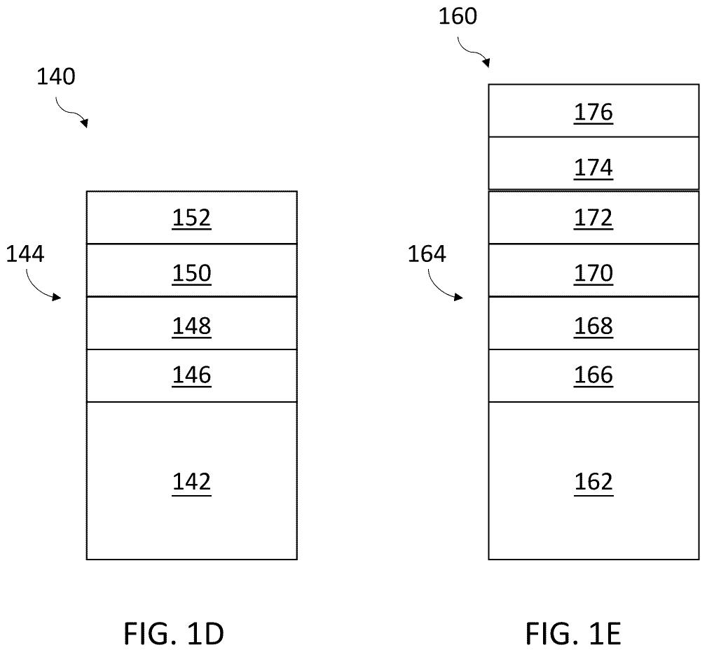

Substrates may be of any appropriate shape or size. Examples of suitable shapes include rectangular prisms, cubes, triangular prisms, spheres, ovoids, ellipsoids, or other geometric or non-geometric three-dimensional shapes. Substates can also be sheets having a thickness and opposing major surfaces in the shape of rectangles, squares, triangles, circles, ovals, ellipses, or other geometric or non-geometric two-dimensional shapes. Surfaces of the substrate can be planar, concave, convex, irregular, textured, or a combination thereof. Substrate dimensions vary in accordance with the type of substrate (e.g., lenses, solar cells, architectural glass, or others). FIGS. 1A-1E show cross-sectional schematics of exemplary coated substrates.

FIG. 1A depicts exemplary coated substrate 100, including substrate 102 and multilayer coating 104 on one side of the substrate. In some cases, the multilayer coating has two layers. The multilayer coating 104 includes first layer 106 and second layer 108. First layer 106 is a bonding layer formed directly on (e.g., in direct contact with) substrate 102. First layer 106 is between substrate 102 and second layer 108. Second layer 108 is an anti-fog layer on an outer surface of coated substrate 100. Although FIG. 1A depicts a two-layer coating, the coating can include a third layer (e.g., the second layer can be formed directly on (e.g., in direct contact with) the first layer or on an intermediate layer between the first layer and the second layer).

FIG. 1B depicts exemplary coated substrate 110, including substrate 112 and multilayer coatings 114 and 114′. Multilayer coating 114 includes first layer 116 and second layer 118. First layer 116 is a bonding layer formed directly on (e.g., in direct contact with) substrate 112. First layer 116 is between substrate 112 and second layer 118. Second layer 118 is an anti-fog layer on an outer surface of the coated substrate.

Multilayer coating 114′ includes first layer 116′ and second layer 118′. First layer 116′ is a bonding layer formed directly on (e.g., in direct contact with) substrate 112. First layer 116′ is between substrate 112 and second layer 118′. Second layer 118′ is an anti-fog layer on an outer surface of the coated substrate. Multilayer coating 114 can be the same as or different than multilayer coating 114′. First layer 116 can be the same as or different from first layer 116′. Second layer 118 can independently be the same as or different from second layer 118′. Although FIG. 1B depicts two-layer coatings formed on two faces of the substrate, one or both of the coatings can include a third layer (e.g., the second layer can be formed directly on (e.g., in direct contact with) the first layer or on an intermediate layer between the first layer and the second layer).

FIG. IC depicts exemplary coated substrate 120, including substrate 122 and multilayer coating 124. Multilayer coating 124 includes first layer 126, second layer 128, and third layer 130. First layer 126 is a bonding layer formed directly on (e.g., in direct contact with) substrate 122. First layer 126 is between substrate 122 and second layer 128. Second layer 128 is between first layer 126 and third layer 130. Third layer 130 is an anti-fog layer on an outer surface of the coated substrate. Although FIG. 1C depicts a three-layer coating with second layer 128 between first layer 126 and third layer 130, in some cases third layer 130 is between first layer 126 and second layer 128, with second layer 128 being an anti-fog layer on an outer surface of the coated substrate.

FIG. ID depicts exemplary coated substrate 140, including substrate 142 and multilayer coating 144. Multilayer coating 144 includes first layer 146, second layer 148, third layer 150, and fourth layer 152. First layer 146 is a bonding layer formed directly on (e.g., in direct contact with) substrate 142. First layer 146 is between substrate 142 and second layer 148. Second layer 148 is between first layer 146 and third layer 150. Third layer 150 is between second layer 148 and fourth layer 152. Fourth layer 152 is an anti-fog layer on an outer surface of the coated substrate. In some examples, the second layer is the same as the fourth layer. In some examples, the third layer is the same as the first layer. In some cases, first layer 146 and second layer 148 may be repeated one or more times (e.g., third layer 150 and fourth layer 152 are the same as first layer 146 and second layer 148, respectively, and so forth, for each two additional layers). In these cases, the first and third layers have the properties of a bonding layer, and the second and fourth layers have the properties of an anti-fog layer.

FIG. 1E depicts exemplary coated substrate 160, including substrate 162 and multilayer coating 164. Multilayer coating 164 includes first layer 166, second layer 168, third layer 170, fourth layer 172, fifth layer 174, and sixth layer 176. First layer 166 is a bonding layer formed directly on (e.g., in direct contact with) substrate 162. First layer 166 is between substrate 162 and second layer 168. Second layer 168 is between first layer 166 and third layer 170. Third layer 170 is between second layer 168 and fourth layer 162. Fourth layer 172 is between third layer 170 and fifth layer 174. Fifth layer 174 is between fourth layer 172 and sixth layer 176. Sixth layer 176 is an anti-fog layer on an outer surface of the coated substrate. In some examples, the second and fourth layers are the same as the sixth layer. In some examples, the third and fifth layers are the same as the first layer. In some cases, first layer 166 and second layer 168 may be repeated one or more times (e.g., third layer 170 and fourth layer 172 are the same as first layer 166 and second layer 168, respectively; fifth layer 174 and sixth layer 176 are the same as first layer 166 and second layer 168, respectively; and so forth, for each two additional layers). In these cases, the first, third, and fifth layers have the properties of a bonding layer, and the second, fourth, and sixth layers have the properties of an anti-fog layer. In some cases, additional repeated layer couplets are present.

In embodiments described with respect to FIGS. 1A-1E, first layer is a bonding layer that includes, consists essentially of, or consists of a first optically transparent inorganic material (e.g., ceramic, glass, or any combination thereof). As used herein, an “optically transparent” material generally refers to a material with >60% or >80% transmittance of visible light. A suitable method to determine the optical transparency of a bulk material such as a substrate is to measure its transmittance spectrum over the visible spectrum using a spectrophotometer, from which the average transmittance, weighted by a spectral response function, may be calculated. A suitable method to determine the optical transparency of one or more layers is to deposit it or them onto an optically transparent substrate (e.g., glass or polycarbonate) and similarly calculate the average transmittance of the combined layer(s) and substrate. Herein, the reported average transmittance, reflectance, and absorptance values (or change in these values after adding a coating to a substrate) are calculated with this method using the CIE standard illuminant D65 spectrum as the weighting function. The optically transparent inorganic material in the bonding layer is bonded (e.g., covalently bonded) to the substrate. The optically transparent inorganic material in the bonding layer is also bonded (e.g., covalently bonded) to the second layer. The bonding layer can enhance the adhesion of the second layer to the substrate without introducing increased average reflectance, average absorptance, reflected or transmitted color, or a combination thereof. The composition, thickness, and microscopic structure of the bonding layer can be selected to achieve a desired combination of properties. In some cases, the optically transparent inorganic material in the bonding layer includes or consists of a first metal oxide, such as titanium dioxide, TiO₂. A thickness of the bonding layer is typically in a range of about 5 nm to about 25 nm, or about 6 nm to about 12 nm. A refractive index of the bonding layer is typically in range of about 1.8 to about 2.2, or about 1.9 to about 2.1. The refractive index can be controlled at least in part through porosity. Porous layers behave as effective media, having refractive indices intermediate between that of their constituent solid and void phases, when their pores are small enough to negligibly scatter visible light. The refractive index of a layer can be measured using spectroscopic ellipsometry, and the porosity of a layer may be estimated using the Bruggeman effective medium approximation.

The anti-fog layer on an outer surface of the coated substrate (e.g., second layer 108 in FIG. 1A, second layers 118 and 118′ in FIG. 1B, third layer 130 in FIG. 1C, fourth layer 152 in FIG. 1D, and sixth layer 176 in FIG. 1E) includes or consists of a second optically transparent inorganic material. The optically transparent inorganic material in the anti-fog layer is hydrophilic, and the microscopic structure of the anti-fog layer can enhance the intrinsic hydrophilicity of the material. The anti-fog layer can reduce fogging of the substrate without introducing increased average reflectance, average absorptance, reflected or transmitted color, or a combination thereof. In some cases, the optically transparent inorganic material in the anti-fog layer is a second metal oxide, such as silicon dioxide, SiO₂. The optically transparent inorganic material in the anti-fog layer can be the same as or different from the optically transparent inorganic material in the bonding layer. A thickness of the anti-fog layer is typically in a range of about 50 nm to about 1000 nm, or about 75 nm to about 200 nm. A refractive index of the anti-fog layer is typically in a range of about 1.20 to about 1.45, or about 1.25 to about 1.40. The refractive index can be controlled through porosity. A lower refractive index (higher porosity) may result in the anti-fog layer providing anti-reflection behavior on some substrates. That is, the average reflectance of a substrate having an anti-fog layer may be lower than the average reflectance of the substrate alone. Accordingly, the average transmittance of a transparent substrate having an anti-fog layer may be higher than the average transmittance of the substrate alone. An average surface roughness Rₑ of the anti-fog layer is typically in a range of about 25 nm to about 150 nm, or about 30 nm to about 80 nm. (For simplicity, surface roughness is not shown in FIGS. 1A-1E, but any of the layers may have surface roughness.) Surface roughness may enhance the hydrophilicity of the layer. Surface roughness Rₑ of an individual layer may be measured using spectroscopic ellipsometry by modeling the surface of the layer with a 50%/50% Bruggeman effective medium approximation having constituent refractive indices of the media on either side of the rough interface of interest and fitting for the thickness (the surface roughness, Rₑ). In some cases, the anti-fog layer is formed of particles having a dimension (e.g., diameter) in a range of about 5 nm to about 300 nm when the layer is imaged using a scanning electron microscope.

Other layers in the multilayer coating (e.g., second layer 128 in FIG. 1C; second layer 148 and third layer 150 in FIG. 1D; and second layer 168, third layer 170, fourth layer 172, and fifth layer 174 in FIG. 1E) may be optical layers. As used herein, an “optical layer” is selected to modify the average transmittance, average reflectance, average absorptance, reflected or transmitted color, or a combination thereof of the multilayer coating. The composition, thickness, refractive index, and microstructure of an optical layer can be selected to achieve a desired combination of properties. An optical layer is composed of optically transparent inorganic material. The optically transparent inorganic material in an optical layer can be the same as or different than the optically transparent inorganic material in the bonding layer or the optically transparent inorganic material in the anti-fog layer. Other layers in the multilayer coating may provide functionality in addition to that attributed to an optical layer, including enhancing the anti-fog performance of the multilayer coating or the mechanical integrity of the multilayer coating.

A multilayer coating, like those depicted in FIGS. 1A-1E, can reduce fogging, provide desirable optics, and have excellent durability. Anti-fog properties are evaluated as described herein (see also, e.g., “Anti-Fog Properties”). A substrate's resistance to fogging can be measured by placing the substrate, coated side down (if coated), over a bath of warm water for one or more minutes and observing the clarity of an image seen through the substrate. The substrate's water contact angle may be measured with a contact angle goniometer or similarly suitable instrument. Surfaces with lower water contact angle have greater hydrophilicity and are associated with better anti-fogging performance. In one example, treatment as described herein resulted in a polycarbonate coated substrate with a water contact angle of <10°. A water contact angle of <10° typically reduces or eliminates visible condensation (fogging). As used herein, a “hydrophilic” surface generally refers to a surface on which the water contact angle is <10°.

Desirable optics for a coated substrate depend in part on the application in which the substrate will be used. In some instances, it is desirable for the coating to increase or maintain the average transmittance of the substrate, reduce or maintain the average reflectance of the substrate, and reduce or maintain the average absorptance of the substrate. The average transmittance may be determined by measuring the transmittance spectrum of the coated substrate over the visible spectrum using a spectrophotometer and calculating the spectral average transmittance, weighted by the spectral response of the human eye. The average reflectance may be similarly determined from the reflectance spectrum, and the average absorptance may be determined by subtracting the average transmittance and average reflectance from 100%. In some instances, it is desirable for a coated substrate to have similar apparent color to an uncoated substrate. As used herein, “uncoated substrate” refers to the substrate before a coating has been applied to the surface or surfaces that have been coated to form the coated substrate. The color difference between two samples can be quantified by ΔE, calculated according to the CIEDE2000 standard. ΔE_{reflected} quantifies the color difference between the reflected light from a coated substrate and that from an uncoated substrate. ΔE_{transmitted} quantifies the color difference between the transmitted light through a coated substrate and that through an uncoated substrate. In some instances, it is desirable for the coating to decrease or maintain the diffuse transmittance (light scattering) of the substrate. Diffuse transmittance may be determined using the same procedure as is described herein for average transmittance but with the diffuse (specular-free) transmittance spectrum. In one example, treatment as described herein resulted in a coated polycarbonate substrate with an average transmittance of 87.7%, average reflectance of 5.3%, ΔE_{reflected} of 5.8, ΔE_{transmitted} of 0.8, and diffuse transmittance of 1.7%. For reference, an uncoated polycarbonate substrate had an average transmittance of 85.2%, average reflectance of 9.3%, and diffuse transmittance of 1.3%. In some instances, it is desirable for a coated substrate to have a reflectance or transmittance spectrum that has the same spectral shape as the reflectance or transmittance spectrum of an uncoated substrate, respectively, but shifted to a different intensity. This is similar to, but not mathematically the same as, the coated and uncoated substrate having the same color (and thus low ΔE). To compare the shape of spectra measured on coated and uncoated substrates, the coated spectrum of one is first subtracted from the other to produce a difference spectrum, Dλ). The flatness of that difference spectrum is then computed by calculating its standard deviation from its mean value:

$$STD = \sqrt{\frac{{\sum }_{λ = 380 nm}^{λ = 1000 nm} {\{ D ( λ ) - Mean [ D ( λ ) ] \}}^{2}}{N}}$$

Here, N is the number of points in the spectra and 380 nm and 1000 nm are the limits of the wavelengths considered in the calculation. In one example, treatment as described herein resulted in a coated polycarbonate substrate with an average decrease in reflectance of >3% (relative to the uncoated substrate) and reflectance STD<1.5.

A multilayer coating with an AF layer (or with AFAR layers) can be resistant to abrasion and chemical attack. Abrasion resistance may be assessed by measuring a coated substrate's water contact angle and optical properties after Taber linear abrasion. Chemical resistance may be assessed by measuring a coated substrate's water contact angle and optical properties after soaking in chemical baths. Small or no changes in water contact angle and optical properties are desirable and representative of excellent coating durability. In one example, treatment as described herein results in a coated polycarbonate substrate with a water contact angle of <10° after 250 abrasion cycles on a Taber linear abraser with cheese cloth soaked in deionized water and a pressure of 3 lb/in². In another example, treatment as described herein results in a coated polycarbonate substrate with a water contact angle of <10° after 24 hours of soaking in deionized water, deionized water with detergent, isopropanol, window cleaner containing ammonium hydroxide. In another example, treatment as described herein results in a coated polycarbonate substrate with a change in average reflectance of <0.2% after 250 abrasion cycles on a Taber linear abraser with cheese cloth soaked in deionized water and a pressure of 3 lb/in². In another example, treatment as described herein resulted in a coated polycarbonate substrate with a change in average reflectance of <0.3% after 24 hours of soaking in deionized water, deionized water with detergent, isopropanol, or window cleaner. In another example, treatment as described herein results in a coated polycarbonate substrate with a change in ΔE_{reflected}<0.2 after 250 abrasion cycles on a Taber linear abraser with cheese cloth soaked in deionized water and a pressure of 3 lb/in². In another example, treatment as described herein results in a coated polycarbonate substrate with a change in ΔE_{reflected}<0.4 after 24 hours of soaking in deionized water, deionized water with detergent, isopropanol, or window cleaner.

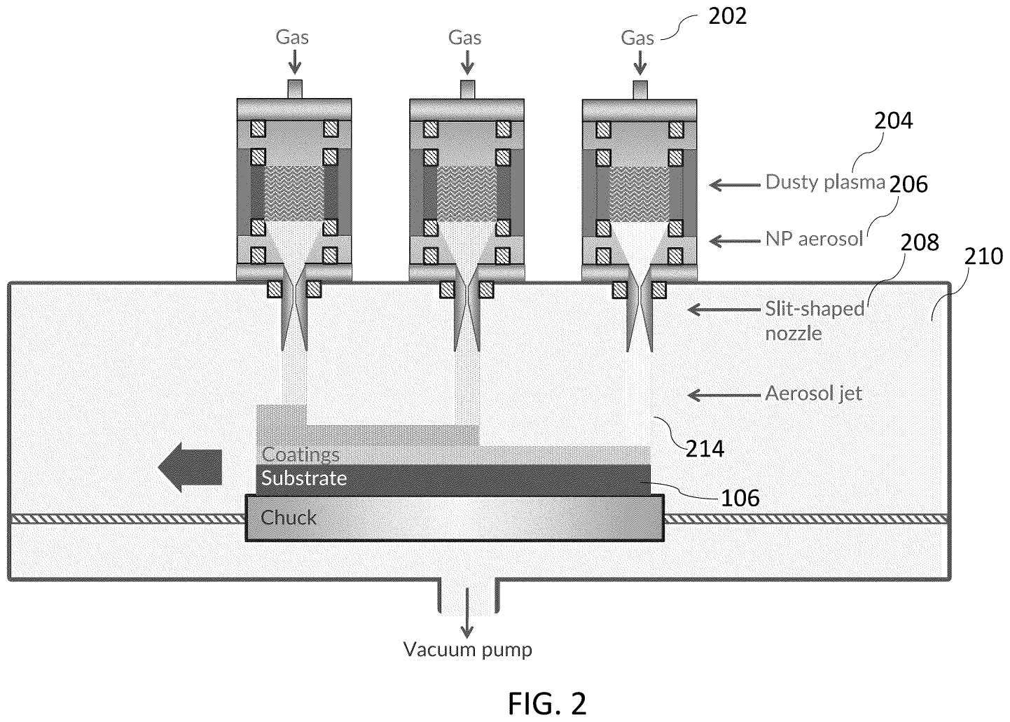

FIG. 2 shows a schematic of an AIDA system and the AIDA deposition process. Additional details are provided in U.S. Pat. No. 11,186,192, which is incorporated herein by reference. AIDA is a dry spray process that can be used to deposit multilayer coatings of optically transparent inorganic materials onto substrates. AIDA can produce layers with tunable porosity (and thus tunable refractive index) and surface roughness on substrates, including bonding layers, anti-fog layers, and optical layers. AIDA provides control of porosity and surface roughness by assembling layers from nanoparticles. Nanoparticles that are sprayed onto the substrate in a manner that cause them to pack closely together or to coalesce form dense layers with higher relative refractive index; nanoparticles that pack less closely together form porous layers with lower relative refractive index. The nanoparticles may include optically transparent inorganic materials by synthesizing the nanoparticles in a plasma (prior to their deposition) from precursor gases or vapors that react to form such materials in the plasma environment.

As depicted in FIG. 2, exemplary AIDA system 200 includes one or more plasma reactors for production of nanoparticles. Precursor gases or vapors 202 are provided to plasma reactor 204 under conditions selected to form nanoparticles 206. The flow of the precursor gases can be several standard liters per minute (SLM). Examples of suitable precursor gases include O₂, SiH₄, and organometallic molecules. An example of a suitable process conducive to nucleating nanoparticles includes plasma-enhanced chemical vapor deposition (PECVD)-like processes. The gas flow moves the nanoparticles downstream where they are accelerated through a slit-shaped nozzle 208 into a roughly evacuated chamber 210 maintained at a pressure ranging from approximately 13 Pa (0.1 Torr) to 667 Pa (5 Torr). As substrate 106 is passed through a curtain of nanoparticles 214 exiting one or more slit-shaped nozzles, the particles impact and stick to the substrate to form a layer. Deposition can occur at room temperature. Room-temperature deposition can be compatible with plastic substrates (e.g., polycarbonate). In some cases, subsequent high-temperature treatments, solvents, organic molecules, or any combination thereof can be omitted in the AIDA deposition process. Adjusting process and hardware parameters (e.g., chamber pressure, total gas flow, nozzle-to-substrate distance, nozzle geometry) allows the nanoparticles' impact velocity to be modulated. Modulation of the nanoparticle impact velocity can be used to manipulate the deposited layer structure (e.g., porosity and surface roughness).

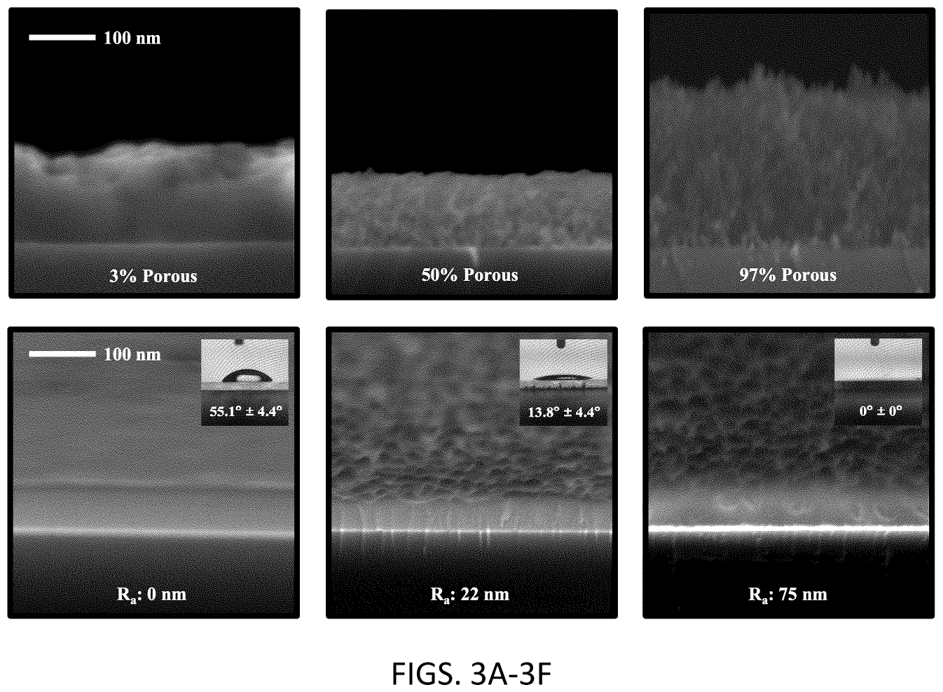

FIGS. 3A-3F show scanning electron microscope (SEM) images of cross sections of layers deposited with AIDA. FIGS. 3A-3C show SEM images of SiO₂ layers with porosity varying from 3% to 97%, respectively. FIGS. 3D-3F show SEM images of SiO₂ layers with average surface roughness measured by atomic force microscopy (AFM), Rₐ, varying from 0 nm to 75 nm, respectively, with corresponding water contact angle images. The pore size is sufficiently small and the pore distribution is sufficiently uniform that the layer can behave as an effective medium. The size of the features that make up the rough surface are sufficiently small that wetting behavior is governed by the Wenzel equation. A change in the layer's porosity can produce a change in the layer's effective refractive index. A change in the layer's surface roughness (Rₐ or Rₑ, depending on measurement method) can produce a change in the water contact angle.

To form a multilayer coating, a substrate may first be subjected to one or more cleaning processes. These may include exposure to oxygen plasma, sonication or agitation in a liquid detergent, dips in an acidic or basic liquid solution, blowing with a nitrogen or other gas jet, or any other suitable method. Cleaning the substate can enhance the bonding of the bonding layer to the substrate. The substrate may then be loaded into an AIDA deposition tool and passed under one or more slit-shaped nozzles one or more times to deposit a bonding layer. The composition of the layer is determined by the gases or vapors and the plasma conditions, the thickness of the layer is determined by the speed and number of times that the substrate is passed under the nozzle, and the porosity and surface roughness are determined by process parameters that govern the nanoparticles' impaction. The substrate may be subsequently passed under one or more slit-shaped nozzles one or more times to deposit an anti-fog layer. Optionally, other layers may be deposited between the bonding and anti-fog layers, as described herein. The layers may be deposited in the same AIDA tool, with different nozzles used for each layer (inline deposition); the layers may be deposited in the same AIDA tool with the same nozzles used for each layer (sequential deposition); or the layers may be deposited in multiple AIDA tools with the substrate being loaded in and unloaded from each tool (batch deposition). The substrate may be heated after the deposition of a layer in the multilayer coating. Suitable heating methods include hot plates, infrared lamps, heated gas jets, furnaces, ovens, or other known methods. Heating may happen in an AIDA tool or using a separate piece of equipment after unloading the substrate from an AIDA tool. Heating one or more layers in the coating may densify select layers.

### EXAMPLES

In one example, the substrate is an exploration extravehicular mobility unit's (xEMU) helmet bubble or a substrate that will be formed, after coating, into a helmet bubble, and the multilayer coating provides both anti-fog and anti-reflection (AFAR) properties. AFAR coating design parameters may include not reducing total transmittance through the helmet below 70%; not increasing diffuse transmittance above 3%; having a water contact angle below that of uncoated polycarbonate (e.g., below) 10°; operating in a low-pressure spacesuit environment without emitting vapors that may irritate the wearer's eyes or lungs (off-gassing test); sufficient durability in the presence of spit, skin oils, vomit, abrasion by simulated facial hair, pressure cycling, and UV exposure; uniform application at a scale large enough to encompass the xEMU helmet; or any combination thereof.

Durability tests of the xEMU helmet bubble include simulated breathing, ≥4B cross hatch test (ASTM 3359), 1000 cycles of simulated cleaning with water, 1000 cycles of simulated cleaning using isopropanol (IPA), 1000 cycles of simulated cleaning using a window cleaner, 1000 cycles of simulated cleaning using a 50% water-50% dish soap mixture, exposure to and removal of spit, skin oils, and vomit, facial hair abrasion, UV exposure, or any combination thereof.

Optical Simulations. An optical model was developed to simulate AFAR coatings on an xEMU helmet. The bubble of the xEMU helmet is made of a Plaskolite™ product, TUFFAK® GP. TUFFAK® GP is a polished, UV-stabilized, high-transparency polycarbonate with no hardcoat. At the thickness used in the xEMU helmet, 3.175 mm (⅛ inch) to 6.86 mm (0.27 in), TUFFAK GP has an average transmittance of approximately 85%. A suitable coating will not reduce this transmittance below 70%. A preferred coating will typically increase transmittance compared to the uncoated substrate. An optical model of a typical substrate was made to assist development of a preferred coating. Using a known achievable refractive index range for layers deposited using AIDA, the optical performance (e.g., transmittance and reflectance) of possible multilayer coatings was simulated.

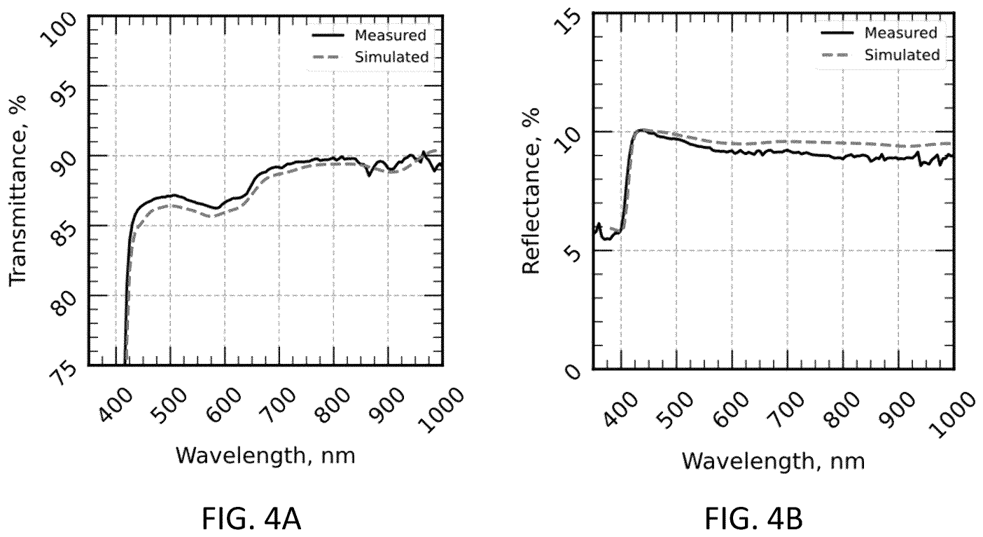

Transmittance and reflectance measurements of TUFFAK® GP were acquired using a Hunterlab Ultra-Scan Pro spectrophotometer with an integrating sphere. The measured transmittance and reflectance spectra can be seen in the solid line in FIGS. 4A and 4B, respectively. Ellipsometry measurements of TUFFAK® GP were taken with a JA Woollam M-2000 variable angle spectroscopic ellipsometer. Using JA Woollam's CompleteEase software, a Cauchy Model for the optical constants was simultaneously fit to the reflectance, transmittance, and ellipsometry data in the transparent region of the substrate (500-1000 nm). The optical constants determined from the Cauchy Model were then used as an initial input to a more complex B-Spline model. The B-Spline model was used to capture absorption in the substrate. The Transfer Matrix Method (TMM) was then used with the optical constants determined by the B-Spline model to simulate reflectance and transmittance spectra for the TUFFAK® GP. The simulated spectra are the dashed lines in FIGS. 4A and 4B. The simulated spectra approximately match both the shape and intensity of the measured spectra, confirming that the simulation methodology can be used to predict real-world performance.

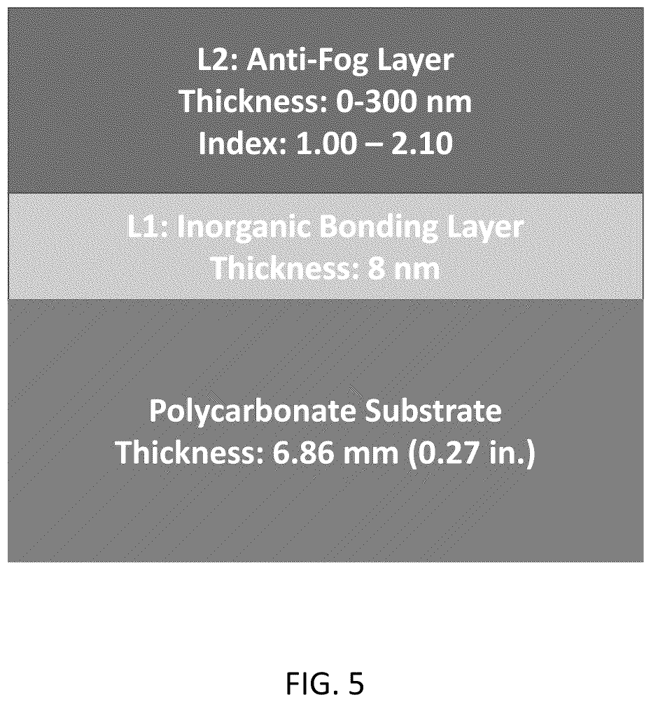

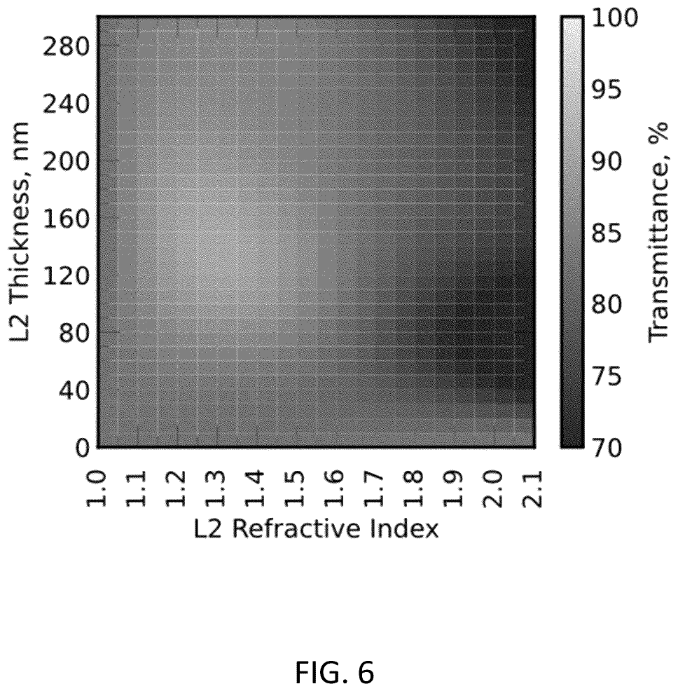

To identify multilayer coating structures that would produce the desired optical performance, 600 unique two-layer coating structures were simulated. Each structure included an 8 nm thick TiO₂ bonding layer deposited by AIDA and a theoretical anti-fog layer of variable thickness and refractive index. A diagram of the simulated structures is shown in FIG. 5. Properties of the polycarbonate substrate and TiO₂ bonding layer were held constant while thickness and refractive index (n) of the anti-fog layer were varied. The results of these simulations are summarized in FIG. 6. FIG. 6 plots the average transmittance for various thickness and refractive index combinations of the anti-fog layer. FIG. 6 indicates that a range of simulated structures demonstrate an average transmittance greater than 70% and that a range of structures demonstrate an average transmittance greater than 85%. Structures with anti-fog layers having refractive indexes between 1.25 and 1.35 were selected. The data in FIG. 6 suggest that the average transmittance of uncoated polycarbonate may be increased by 2-5% due at least in part to the deposition of anti-fog layers with refractive indexes between 1.25 and 1.35. The range of refractive indexes corresponds to layer porosities between 20% and 40% if the layer comprises SiO₂, which typically corresponds to SiO₂ layers exhibiting good mechanical durability when deposited by AIDA.

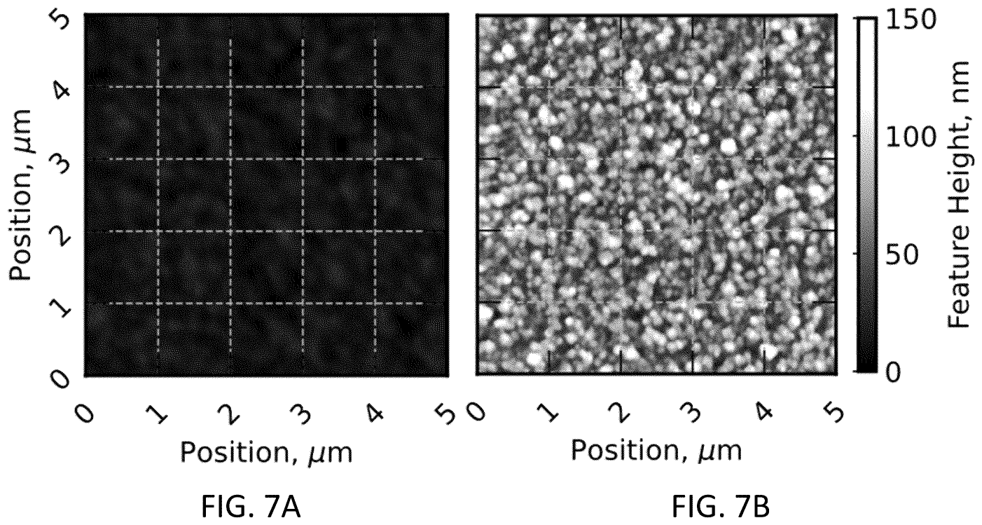

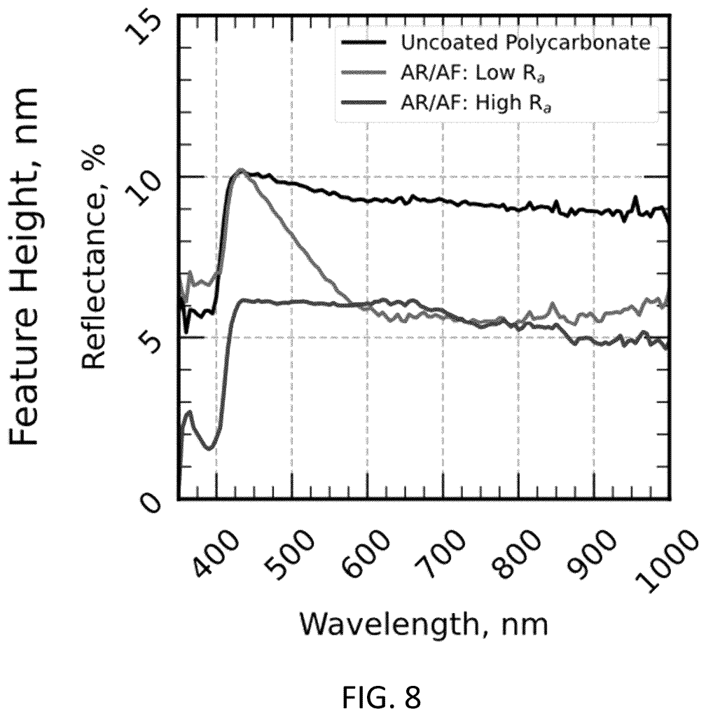

Fabricated Coatings. Using the optical simulations as a guide, AFAR coatings having anti-fog layers with a range of refractive indexes (n) and thicknesses were fabricated on TUFFAK® GP polycarbonate substrates. Two coated substrates of interest are compared in FIG. 7-9. One has two layers, per the structure in FIG. 1A: TiO₂/SiO₂ (from the substrate to the coating outer surface). The TiO₂ layer was approximately 8 nm thick with a refractive index of approximately 2.0 and a surface roughness Rₑ of approximately 0 nm, as determined by fitting ellipsometry measurements of a single-layer TiO₂ witness coating on glass with a model that included a surface roughness layer, as described herein. The SiO₂ layer was approximately 110 nm thick with a refractive index of approximately 1.40 and a surface roughness Rₑ of approximately 0 nm. The other coating had six layers, per the structure in FIG. 1E, arranged in (three) repeated couplets: TiO₂/SiO₂/TiO₂/SiO₂/TiO₂/SiO₂ (from the substrate to the coating outer surface), with each TiO₂ layer being nominally the same and each SiO₂ layer being nominally the same. The TiO₂ layers were approximately 8 nm thick with a refractive index of approximately 2.0 and a surface roughness Rₑ of approximately 0 nm. The SiO₂ layers were approximately 120 nm thick with a refractive index of approximately 1.25 and a surface roughness Rₑ of approximately 50 nm. The differences between the two multilayer coatings are thus the number of layers and the refractive index and roughness of the SiO₂ layers. Topography measurements of the outer surfaces of the coatings were collected using AFM and are presented in FIGS. 7A and 7B. FIG. 7A shows a map of topography of the first coating, which has a low Rₐ and will be referred to accordingly hereafter, and FIG. 7B shows a map of topography of the second coating, which has a high Rₐ and will be referred to accordingly hereafter. AFM data show that the low Rₐ coating had an average surface roughness of 10 nm, and the high Rₐ coating had an average surface roughness of 75 nm; these roughnesses are qualitatively consistent with what is expected from the Rₑ values of the individual layers measured via ellipsometry. FIG. 8 shows reflectance spectra of an uncoated polycarbonate substrate (upper trace) and polycarbonate substrates coated with the low Rₐ (intermediate trace, touching both upper and lower traces) and high Rₐ (lower trace) AFAR coatings. The low Rₐ and high Rₐ coatings provide a reduction in reflection compared to uncoated polycarbonate. The greater surface roughness of the high Rₐ coating produces a flatter spectrum, providing a more color-neutral appearance. This is apparent in the measured reflectance STD values of 0.65 for the high Rₐ coating and 1.65 for the low Rₐ coating.

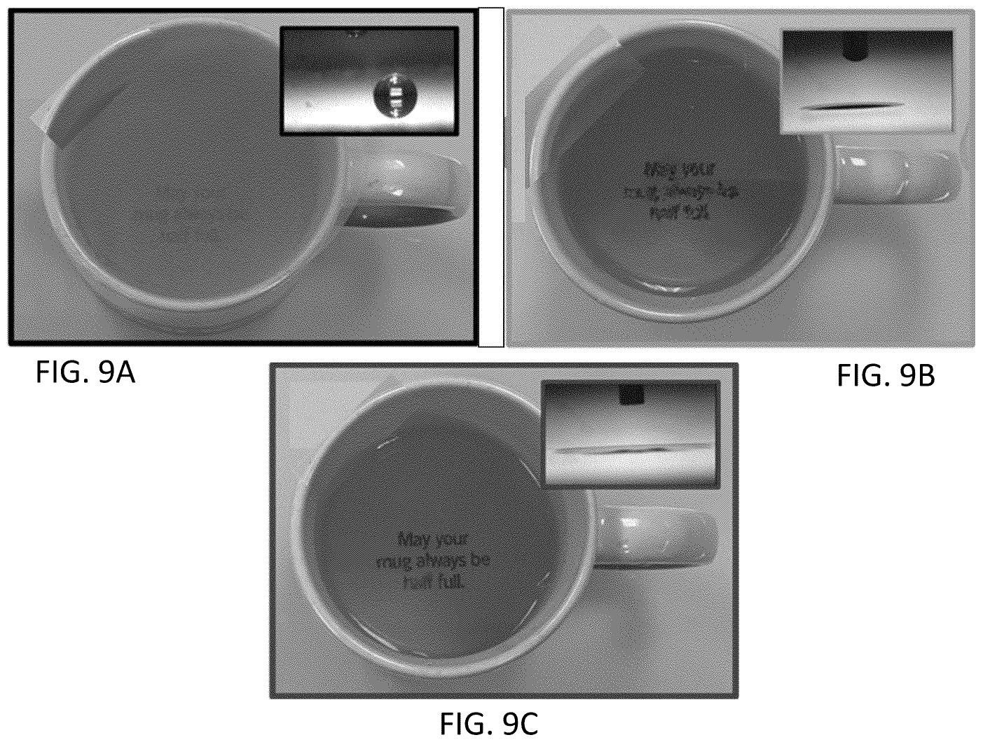

Anti-Fog Properties. Anti-fog properties of AFAR coatings were evaluated using a “coffee cup test” and contact angle measurements. The coffee cup test includes placing a room temperature sample on top of a vessel (e.g., a coffee cup) containing hot water, where the vessel includes one or more visible objects at the bottom of the vessel (e.g., text). The water can range from 50° C. to 90° C. Samples remain on top of the vessel for approximately 30 seconds as hot water vapor condenses on the cooler sample surface. A photograph of a sample in this state was evaluated by eye to provide an evaluation of the anti-fog performance of the sample's surface facing the coffee cup. Contact angle measurements were performed using a VCA Optima XE contact angle system. FIGS. 9A-9C show anti-fog performance during the coffee cup test of the high and low Rₐ AFAR coatings compared to uncoated polycarbonate. FIG. 9A shows a photograph of uncoated polycarbonate. FIG. 9B shows polycarbonate coated with the low Rₐ AFAR coating, and FIG. 9C shows polycarbonate coated with the high Rₐ AFAR coating. Inset in each image is the water contact angle. Performance on the coffee cup test correlates with contact angle measurements. The low Rₐ AFAR coating and the high Rₐ AFAR coating demonstrate a lower contact angle than uncoated polycarbonate. The low Rₐ coating has a contact angle of approximately 6°. The high Rₐ coating has a contact angle near zero. The uncoated polycarbonate fogs sufficiently to demonstrate reduced visibility of the text at the bottom of the cup. The inset image shows a contact angle of 70° degrees. The low Rₐ coating provides better visibility of the text at the bottom of the cup relative to the text at the bottom of the uncoated polycarbonate surface (FIG. 9A). The text below the low Rₐ coating is distorted and difficult to read. The high Rₐ coating performs best on the coffee cup test, demonstrating text that is visible and undistorted with nearly no visible fogging.

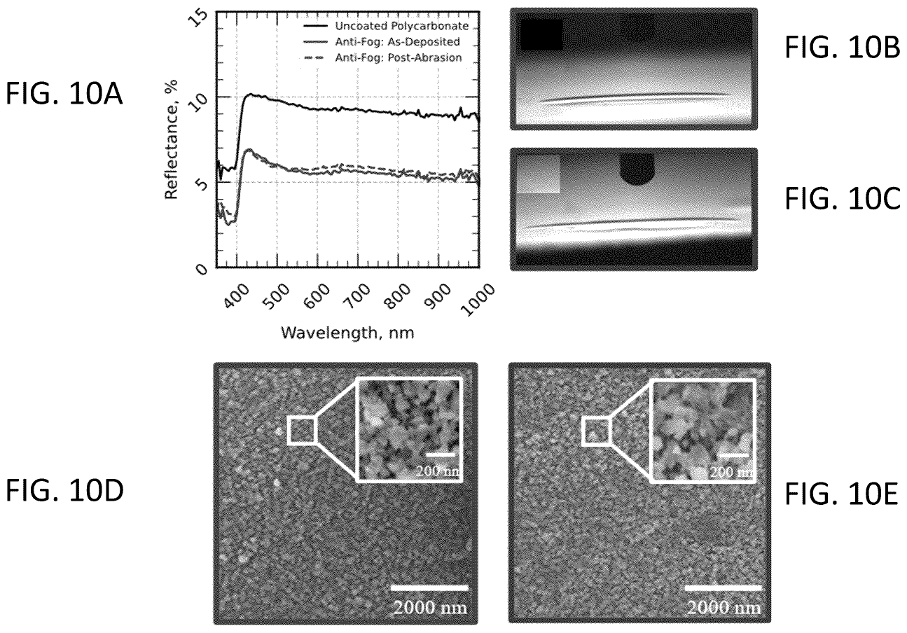

Coating Durability. The high Rₐ AFAR coating was selected to undergo durability testing due at least in part to its optical properties and anti-fog performance. To evaluate the coating's abrasion resistance, a Taber linear abrasion system (Model 5750) was utilized. Cheese cloth soaked in deionized water was selected as the abrasive material with 2.07×10⁴ Pa (3 lb/in²) of normal pressure applied to the 5.08 cm×10.16 cm (2 in×4 in) substrate. The sample was subjected to 250 abrasion cycles at a rate of 60 cycles per minute. FIGS. 10A-10E summarize the results of this test.

FIG. 10A shows reflectance spectra of uncoated polycarbonate (upper solid line) and polycarbonate with the high Rₐ AFAR coating before and after abrasion testing. The post-abrasion reflectance spectrum (dashed line) matches the shape and intensity of the as-deposited spectrum (lower solid line), indicating minimal change to the coating optical performance. FIGS. 10B and 10C are water contact angle images before and after abrasion testing, respectively. Both contact angles are near 0°, demonstrating the anti-fog properties are intact. The AFAR coating's optical and anti-fog performance was maintained after light to moderate scrubbing.

The coating's abrasion resistance can be due at least in part to the structure of the coating. FIGS. 10D and 10E show SEM images of the high Rₐ AFAR coating before and after abrasion testing, respectively. The large image is a 5,000× magnification, top-down view of the sample's surface. The inset image is a 50,000× magnification top-down view of the sample's surface. The SEM images show interconnection (often referred to as “necking”) between particles. Extensive necking can immobilize the material and create a more durable layer.

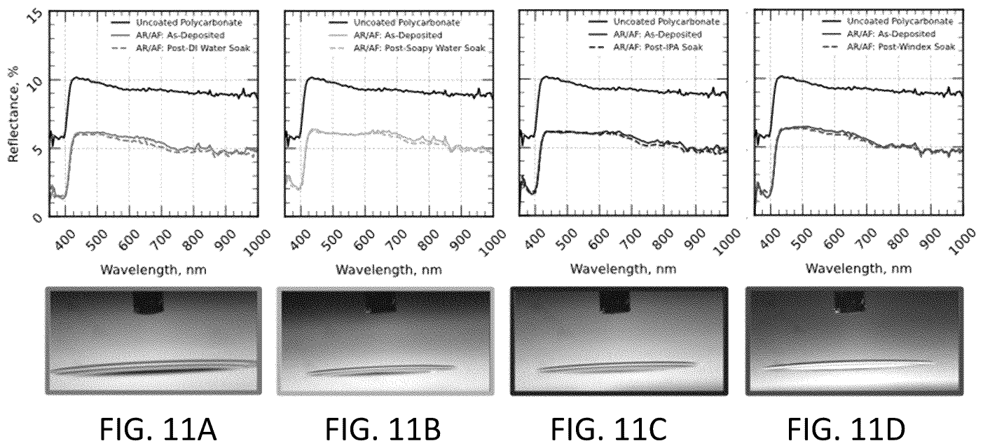

To evaluate the coating's resilience to cleaning agents, the high Rₐ AFAR coating was soaked in four cleaning solutions: (1) deionized (DI) water, (2) DI water with detergent, (3) isopropanol (IPA), and (4) window cleaner. Samples were submerged in the solutions for a total of 24 hours. After the soaks were complete, the samples were removed, rinsed with DI water, and blown dry with compressed nitrogen. FIGS. 11A-11D show reflectance spectra of uncoated polycarbonate (upper solid line), and high Rₐ AFAR coated polycarbonate before (lower solid line) and after (dashed line) soaking in a cleaning solution for 24 hours. FIG. 11A shows reflectance spectra after soaking in DI water for 24 hours. FIG. 11B shows reflectance spectra after soaking in DI water with detergent for 24 hours. FIG. 11C shows reflectance spectra after soaking in isopropanol for 24 hours. FIG. 11D shows reflectance spectra after soaking in a window cleaner for 24 hours. Below each plot are contact angle measurements of each sample after completion of the soak tests. FIGS. 11A-11D show the post-test reflectance spectra match the shape and intensity of the pre-test reflectance spectra. Shape and intensity matching from the pre-test to the post-test reflectance spectra may be due at least in part to minimal change to the coating's structure. The post-test contact angle for tests shown in FIGS. 11A-11D remained near 0°. A near 0° contact angle is due at least in part to intact anti-fog properties.

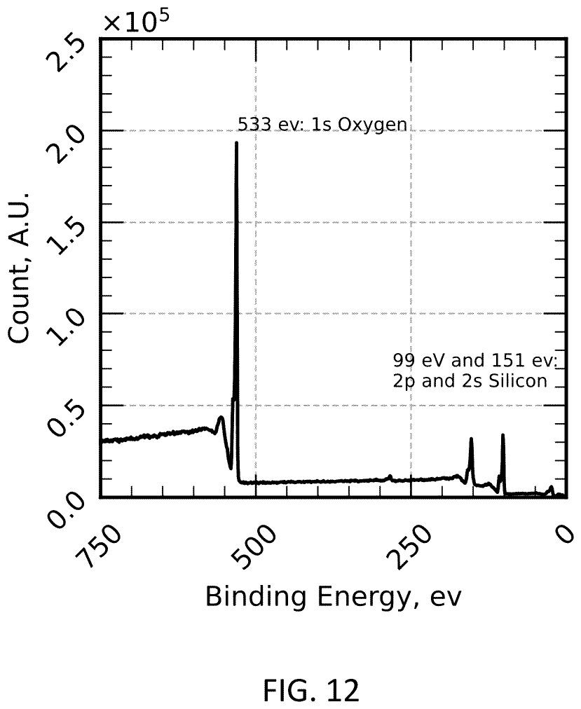

The coating's resilience to the tested cleaning agents may be due at least in part to the coating's composition. FIG. 12 is an X-ray photoelectron spectroscopy (XPS) spectrum of the outer surface of the high Rₐ AFAR coating. The spectrum shows only three peaks: (1) a peak at 99 eV representing the 2p binding energy for silicon, (2) a peak at 151 eV representing the 2s binding energy for silicon, and (3) a peak at 533 eV representing the Is binding energy of oxygen. The spectrum suggests that the outermost layer—the anti-fog layer—is composed of very pure SiO₂, wherein SiO₂ is typically an unreactive material.

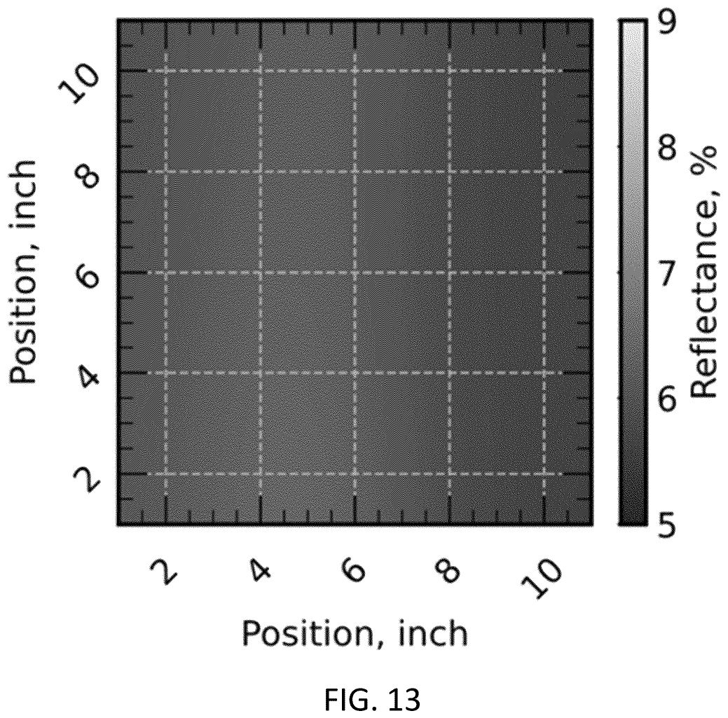

Scaling. To be used in the xEMU helmet, the AFAR coating would need to be applied to a substrate having dimensions of at least approximately 35.6 cm×28 cm (14 in×11 in). The AFAR deposition process was transitioned to an AIDA deposition system capable of coating substrates up to 49.5 cm (19.5 in) wide. As an initial test, the high Rₐ AFAR coating was deposited on a flat 30.5 cm×30.5 cm (12 in×12 in) polycarbonate substrate. To evaluate non-uniformity, 15 reflectance measurements were taken in an equally spaced 5×5 grid pattern. A plot of average reflectance as a function of position is shown in FIG. 13. The spatially averaged average reflectance of the sample was 6.03% +0.29%, representing a non-uniformity of 7.5%.

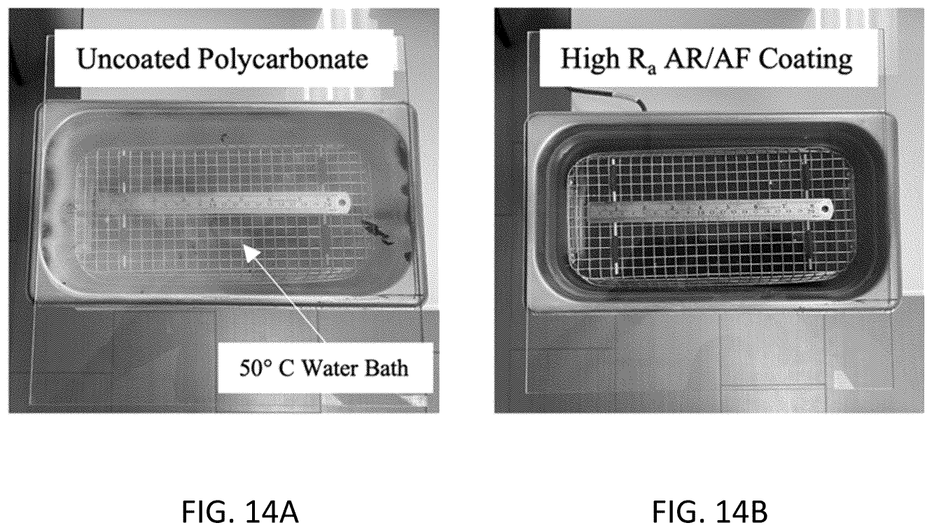

FIGS. 14A and 14B show photographs of 30.5 cm×30.5 cm (12 in×12 in) uncoated and AFAR coated polycarbonate samples, respectively, undergoing a scaled-up version of the anti-fog performance test (“coffee cup test”). In the scaled-up version of the test, the temperature of the water bath was 50° C. rather than 90° C. A high Rₐ AFAR coating on a 30.5 cm×30.5 cm (12 in×12 in) polycarbonate substrate demonstrated reduced fogging compared to uncoated polycarbonate.

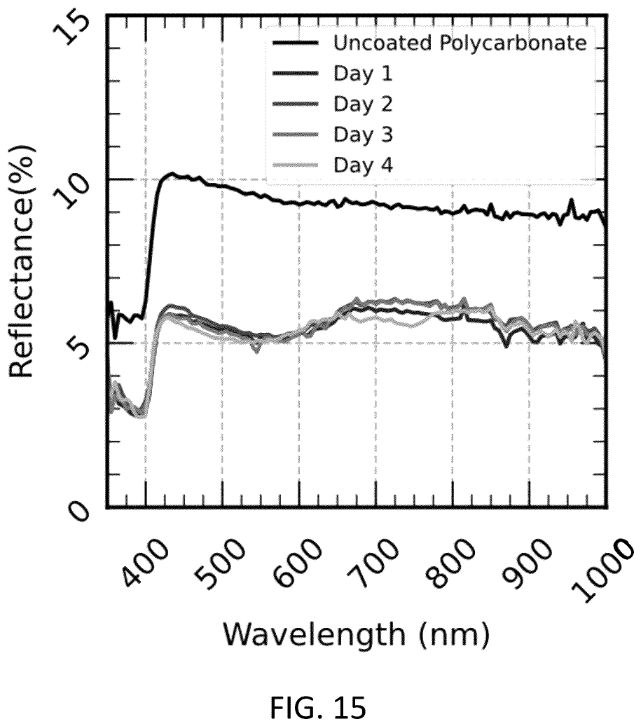

Deposition on 30.5 cm×30.5 cm (12 in×12 in) substrates was used to evaluate the repeatability of the process. Once a day for four days, an AFAR coating was deposited on a 30.5cm×30.5 cm (12 in×12 in) substrate. 15 reflectance measurements were taken on each sample and averaged. The spatially averaged reflectance spectrum of each sample is plotted in FIG. 15. The upper trace is uncoated polycarbonate, and the reflectance spectra of AFAR coated substrates overlap, indicating that the process is sufficiently repeatable.

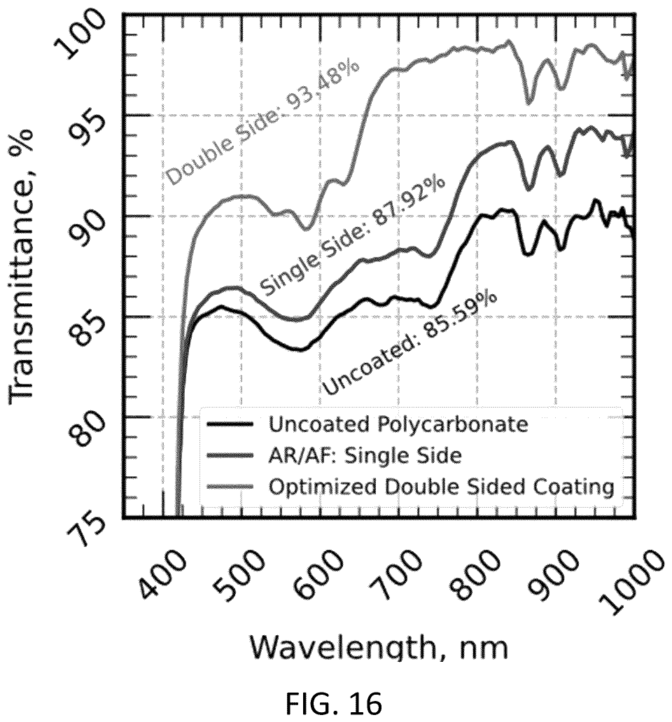

An anti-fog coating on an interior surface of the xEMU helmet was tested. Coating other surfaces within the xEMU helmet is contemplated. Coating other surfaces can provide an additional increase in transmittance. There are six polycarbonate/air interfaces present in the helmet. If six surfaces are uncoated, a total average transmittance of between 60 and 70% can be demonstrated. An AFAR coating for each polycarbonate/air surface in the helmet can increase the total average transmittance by as much as 25% absolute. The design of the AFAR coating was modified to increase transmittance if applied to both sides of a polycarbonate substrate, as in FIG. 1B but with a six-layer coating on each side, as in FIG. 1E. The transmittance spectrum of such a sample is shown in FIG. 16. The double-side-coated substrate (upper trace) had 7.89% absolute higher average transmittance than an uncoated polycarbonate substrate (lower trace).

Coating a hemi-ellipsoidal shape. The xEMU helmet is hemi-ellipsoidal in shape. Two approaches were considered for coating a hemi-ellipsoidal shaped xEMU helmet. One approach includes applying the coating to a flat polycarbonate sheet before it is formed into the final shape, with the coating capable of surviving the forming process. The second approach includes applying the coating to the finished part, with the coating process capable of applying the coating uniformly to a curved substrate. Initial experiments were conducted to evaluate the feasibility of both approaches.

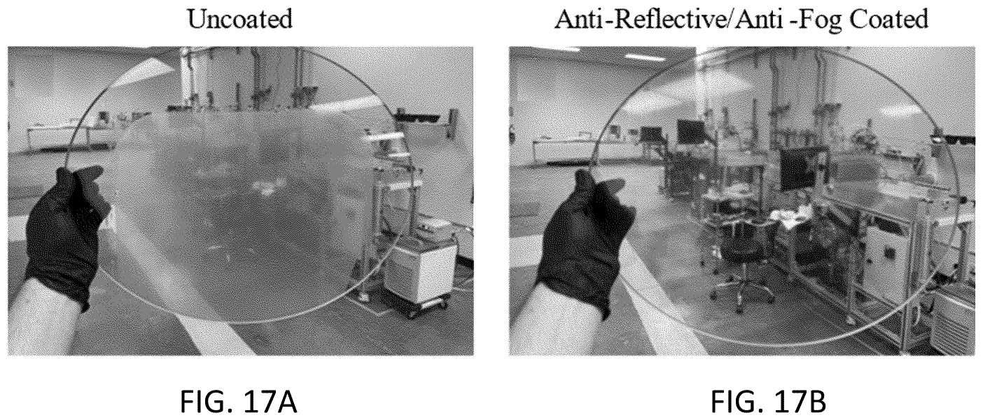

Forming a pre-coated substrate. FIGS. 17A and 17B shows photographs of a flat polycarbonate substrate with and without the AFAR coating, respectively, after undergoing a modified version of the coffee cup test. The uncoated substrate in FIG. 17A showed fogging while the coated substrate shown in FIG. 17B remained clear. The polycarbonate substrate was obtained from the xEMU helmet manufacturer and cut to the appropriate shape for forming before the AFAR coating was applied.

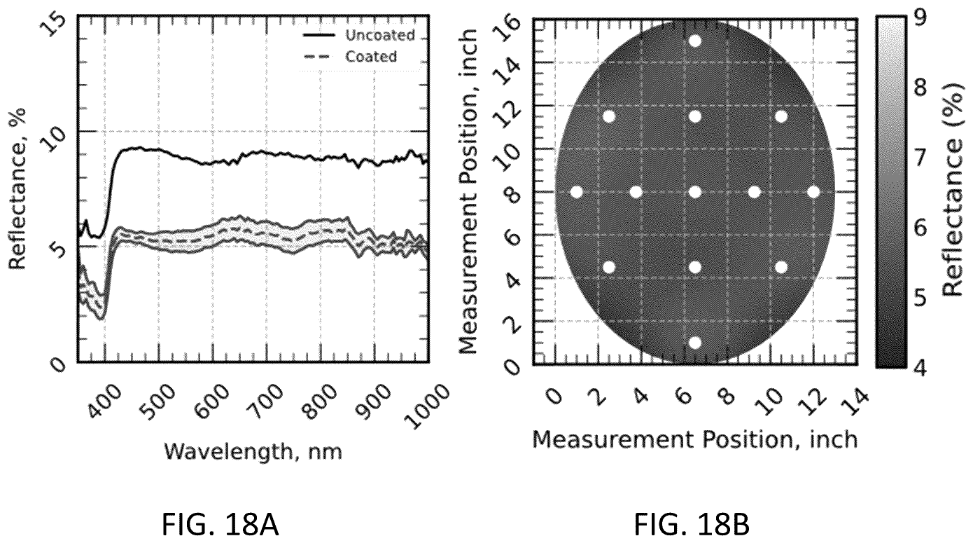

FIGS. 18A and 18B show reflectance measurements of the sample shown in FIG. 17B. FIG. 18A plots the reflectance spectra of the uncoated polycarbonate (upper trace) and the AFAR coated polycarbonate (lower traces). The dashed line represents the spatially averaged reflectance spectrum, and the shaded area represents the 95% confidence interval for 13 points measured at various locations on the substrates. FIG. 18B is a map of the average reflectance of the coated sample. The dots represent the measurement locations. The fogging behavior, spectrum shape, and spectrum intensity are consistent with previous results.

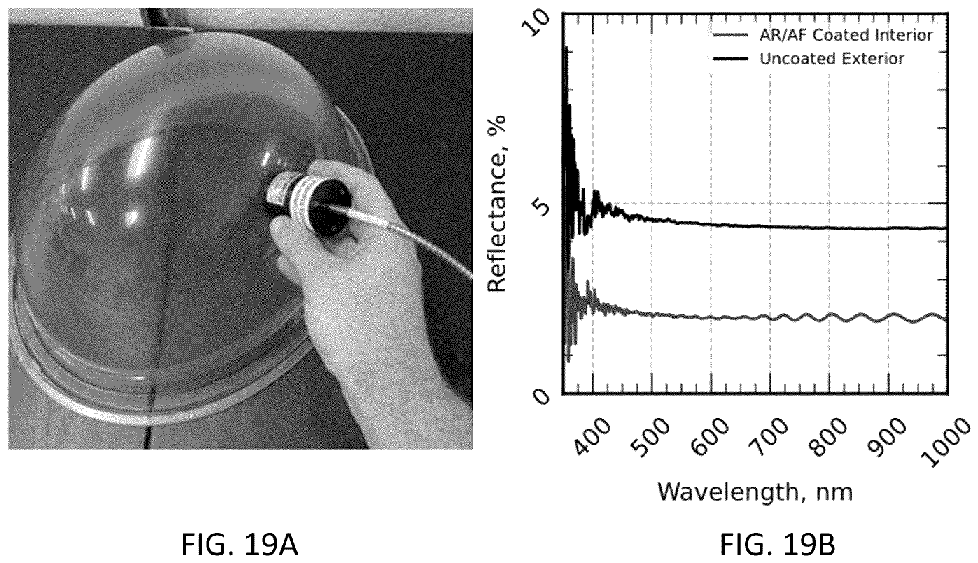

The coated substrate shown in FIG. 17B was subsequently formed into the xEMU helmet shape by a helmet manufacturer by placing the coated substrate first in an oven at 15020 C. for two hours (bake-out) and then in mineral oil at 150° C. for two hours (forming). A visual defect in the helmet was a light haziness. To evaluate if the coating survived the forming process, reflectance measurements of the coated interior and the uncoated exterior were taken using a Filmetrics F20-UV spectrophotometer with a contact probe designed to measure reflectance of curved surfaces. FIG. 19A shows a photograph of the xEMU helmet undergoing a reflectance measurement. The probe is designed such that only reflectance from the surface in contact with the probe is measured (e.g., light reflected off the backside of a sample is not captured). The reflectance spectra of the uncoated exterior (upper trace) and the coated interior (lower trace) are shown in FIG. 19B. The reflectance of the coated interior is approximately 2.5% lower than the exterior, indicating that the AFAR coating is still present on the interior surface.

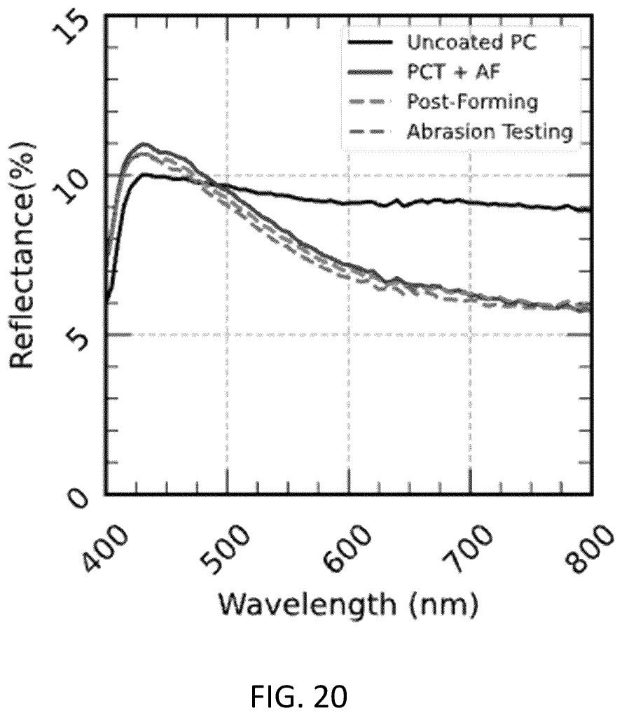

FIG. 20 shows reflectance spectra of uncoated polycarbonate (solid trace with 9% reflectance at 800 nm) and polycarbonate coated with an AFAR coating as deposited (solid trace with 6% reflectance at 800 nm), after a simulated forming process (upper dashed line), and after subsequent abrasion testing (lower dashed line). The reflectance spectra of the coated substrate after each step sufficiently overlap, demonstrating that the coating is still present and sufficiently unchanged.

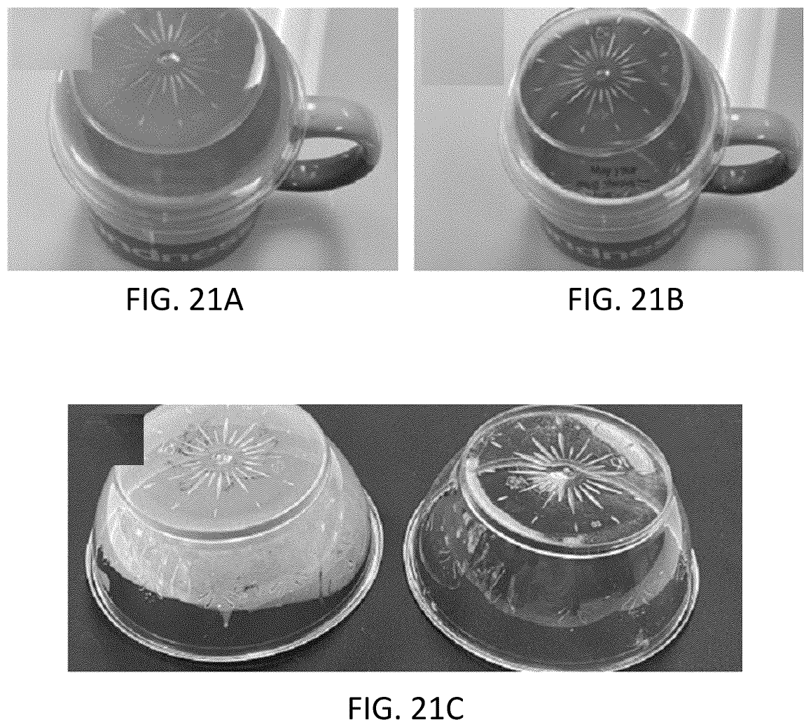

Coating a pre-formed substrate. To test the feasibility of coating a previously curved substrate, a plastic cup with a diameter of 7.62 cm (3 in) and a height of 5.08 cm (2 in) was coated with the AFAR coating. FIGS. 21A-21C show results of AFAR coating deposition onto a curved surface. FIGS. 21A and 21B show photographs of an uncoated plastic cup and a plastic cup coated with the AFAR coating, respectively, undergoing the coffee cup test. The text at the bottom of the mug is visible through the coated cup shown in FIG. 21B and obscured by fog on the uncoated cup shown in FIG. 21A. A sufficient portion of the cup's interior appears to have been coated, as no fog build up is evident. FIG. 21C shows a photograph of the uncoated (left) and coated (right) cups after removal from the coffee cup test and placed against a black background for improved visibility.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A coated substrate comprising:
a substrate;
an anti-fog layer; and
a bonding layer between the substrate and the anti-fog layer, wherein the anti-fog layer comprises SiO₂, and the bonding layer is an optically transparent inorganic material.

2. The coated substrate of claim 1, wherein the anti-fog layer consists of SiO₂.

3. The coated substrate of claim 1, wherein the bonding layer comprises a metal oxide.

4. The coated substrate of claim 1, wherein the bonding layer comprises TiO₂.

5. The coated substrate of claim 4, wherein the bonding layer consists of TiO₂.

6. The coated substrate of claim 1, wherein a thickness of the bonding layer is in a range of about 5 nm to about 25 nm.

7. The coated substrate of claim 1, wherein a refractive index of the bonding layer is in a range of about 1.8 to about 2.2.

8. The coated substrate of claim 1, wherein a thickness of the anti-fog layer is in a range of about 50 nm to about 1000 nm.

9. The coated substrate of claim 1, wherein a refractive index of the anti-fog layer is in a range of about 1.20 to about 1.45.

10. The coated substrate of claim 1, wherein a surface roughness of the anti-fog layer is in a range of about 25 nm to about 150 nm.

11. The coated substrate of claim 1, wherein the anti-fog layer comprises particles having a dimension in a range between about 5 nm and about 300 nm.

12. The coated substrate of claim 1, wherein the substrate is optically transparent.

13. The coated substrate of claim 12, wherein the substrate comprises a polymer.

14. The coated substrate of claim 13, wherein the substrate comprises polycarbonate.

15. The coated substrate of claim 1, wherein the coated substrate has a water contact angle of <10 degrees.

16. The coated substrate of claim 1, further comprising a first optical layer and a second optical layer, wherein the first optical layer is between the bonding layer and the anti-fog layer, and the second optical layer is between the first optical layer and the anti-fog layer.

17. The coated substrate of claim 16, wherein the anti-fog layer and the first optical layer are composed of the same material.

18. The coated substrate of claim 16, wherein the bonding layer and the second optical layer are composed of the same material.

19. The coated substrate of claim 1, further comprising one or more optical layers between the bonding layer and the anti-fog layer.

20. A method of fabricating a coated substrate, the method comprising:
disposing a bonding layer on the substrate and optionally disposing one or more optical layers on the bonding layer to yield an intermediate coated substrate; and
disposing an anti-fog layer on the intermediate coated substrate to yield the coated substrate.
